(19) United States
(12) Patent Application Publication
(10) Pub. No.: US 2026/0154646 A1
(43) Pub. Date: Jun. 4, 2026

(54) METHOD AND SYSTEM FOR MATCHING AGENTS WITH CLIENTS IN MATCHING MARKETS

(71) Applicant: JPMorgan Chase Bank, N.A., New York, NY (US)

(72) Inventors: Daniel NGO, Pittsburgh, PA (US); Vamsi Krishna POTLURU, New York, NY (US); Manuela VELOSO, New York, NY (US)

(73) Assignee: JPMorgan Chase Bank, N.A., New York, NY (US)

(21) Appl. No.: 18/966,831

(22) Filed: Dec. 3, 2024

(51) Int. Cl. G06Q 10/0639; G06Q 10/0631; G06Q 10/0633; G06Q 10/1053

(52) U.S. Cl. CPC G06Q 10/0639; G06Q 10/06316; G06Q 10/0633; G06Q 10/1053

(57) ABSTRACT

A method and a system for matching agents with candidates are provided. The method includes: accessing information that relates to a plurality of agents; accessing information that relates to a plurality of candidates; retrieving a historical listing of pairings between each respective group and each respective category; retrieving a plurality of predetermined reward values, and each predetermined reward value is associated with a corresponding sample pairing; and generating a recommended corresponding pairing for each respective agent and each respective candidate. A probability that the recommended corresponding pairing is generated is based on the historical listing and the plurality of predetermined reward values.

### BACKGROUND

### 1. Field of the Disclosure

This disclosure generally relates to methods and systems for matching agents with candidates, and more particularly to methods and systems for recommending optimal pairings between agents and candidates by incentivizing exploration in matching markets.

### 2. Background Information

Consider an online job market where job applicants seek to get matched with employers in a one-to-one format, i.e., each job opening only accepts a single candidate. Each job applicant has their preference over which position they want to work in to utilize their skill set best. Similarly, employers want to match with candidates with well-documented track records who they can trust to perform well in the new job. This is a canonical example of the one-to-one matching problem. While preference matching is ubiquitous, it may lead to self-imposed bias where job applicants only seek out employers they know beforehand, ignoring other options on the market. At the same time, employers also suffer from a lack of exploration as they are more favorable to prominent job applicants instead of expanding their search for the most suitable candidates. Moreover, in a large market, it is improbable that an employer can form an accurate preference ordering over job applicants without interacting with them first.

Additionally, prior work in incentivized exploration only considers the agents' incentives but does not consider both the agents' and the candidates' incentives. Thus, there is not currently a solution for determining pairings that are advantageous for both the agent and the candidate.

Accordingly, there is a need for recommending optimal pairings between agents and candidates by incentivizing exploration in matching markets. Particularly, a method and system are needed for incentivized exploration in a centralized matching market, where the system provides recommendations for either the job applicants or the employees to explore alternative options. Such exploration is crucial to any learning algorithm that seeks to find the optimal matching in two-sided markets.

### SUMMARY

The present disclosure, through one or more of its various aspects, embodiments, and/or specific features or sub-components, provides, inter alia, various systems, servers, devices, methods, media, programs, and platforms for recommending optimal pairings between agents and candidates by incentivizing exploration in matching markets.

According to an aspect of the present disclosure, a method for matching agents with candidates is provided. The method may be implemented by at least one processor. The method may include: accessing, by the at least one processor, information that relates to a plurality of agents, wherein each respective agent of the plurality of agents is associated with a respective category from among a plurality of categories, and wherein each respective category of the plurality of categories is associated with a respective predetermined feature from a set of features; accessing, by the at least one processor, information that relates to a plurality of candidates, wherein each respective candidate of the plurality of candidates is associated with one respective group from among a plurality of groups, and wherein each respective group of the plurality of groups is associated with a respective predetermined characteristic from a set of characteristics; retrieving, by the at least one processor, a historical listing of pairings between each respective group and each respective category; retrieving, by the at least one processor, a plurality of predetermined reward values, wherein each respective predetermined reward value from among the plurality of predetermined reward values is associated with a corresponding sample pairing from among the historical listing of pairings; and generating, by the at least one processor, a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

The method may further include generating the historical listing of pairings by generating, by the at least one processor, a plurality of sample pairings between each group and each category, wherein the generating of the plurality of sample pairings includes pairing each group with each category at least once over the plurality of sample pairings.

Each respective predetermined reward value may relate to at least one from among an increased profit, an increased production, and an increased performance.

The method may further include: determining, by the at least one processor, which corresponding generated sample pairing of the plurality of sample pairings has a highest respective predetermined reward value from the plurality of predetermined reward values, wherein the probability is inversely proportional to a reward gap that is based on a predetermined preferred pairing reward value of an initial preferred pairing and the highest respective predetermined reward value.

The probability may be greater than or equal to zero.

Each of the plurality of agents may be a potential employer and each of the plurality of candidates may be a potential candidate employee.

Each of the plurality of agents may be a potential financial advisor and each of the plurality of candidates may be a potential client.

Each of the plurality of agents may be a potential computer-based architectural workflow and each of the plurality of candidates may be a potential artificial intelligence (AI) agent.

According to another aspect of the present disclosure, a computing apparatus for matching agents with candidates is provided. The computing apparatus may include a processor; a memory; and a communication interface coupled to each of the processor, and the memory. The processor may be configured to: access information that relates to a plurality of agents, wherein each respective agent of the plurality of agents is associated with a respective category from among a plurality of categories, and wherein each respective category of the plurality of categories is associated with a respective predetermined feature from a set of features; access information that relates to a plurality of candidates, wherein each respective candidate of the plurality of candidates is associated with one respective group from among a plurality of groups, and wherein each respective group of the plurality of groups is associated with a respective predetermined characteristic from a set of characteristics; retrieve a historical listing of pairings between each respective group and each respective category; retrieve a plurality of predetermined reward values, wherein each respective predetermined reward value from among the plurality of predetermined reward values is associated with a corresponding sample pairing from among the historical listing of pairings; and generate a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

The processor may be further configured to generate a plurality of sample pairings between each group and each category, wherein the generating of the plurality of sample pairings includes pairing each group with each category at least once over the plurality of sample pairings.

Each respective predetermined reward value may relate to at least one from among an increased profit, an increased production, and an increased performance.

The processor may be further configured to: determine which corresponding generated sample pairing of the plurality of sample pairings has a highest respective predetermined reward value from the plurality of predetermined reward values, wherein the probability is inversely proportional to a reward gap that is based on a predetermined preferred pairing reward value of an initial preferred pairing and the highest respective predetermined reward value.

The probability may be greater than or equal to zero.

Each of the plurality of agents may be a potential employer and each of the plurality of candidates may be a potential candidate employee.

Each of the plurality of agents may be a potential financial advisor and each of the plurality of candidates may be a potential client.

Each of the plurality of agents may be a potential computer-based architectural workflow and each of the plurality of candidates may be a potential AI agent.

According to yet another aspect of the present disclosure, a non-transitory computer readable storage medium storing instructions for streamlining data processing by transforming data is provided. The storage medium includes executable code which, when executed by a processor, may cause the processor to: access information that relates to a plurality of agents, wherein each respective agent of the plurality of agents is associated with a respective category from among a plurality of categories, and wherein each respective category of the plurality of categories is associated with a respective predetermined feature from a set of features; access information that relates to a plurality of candidates, wherein each respective candidate of the plurality of candidates is associated with one respective group from among a plurality of groups, and wherein each respective group of the plurality of groups is associated with a respective predetermined characteristic from a set of characteristics; retrieve a historical listing of pairings between each respective group and each respective category; retrieve a plurality of predetermined reward values, wherein each respective predetermined reward value from among the plurality of predetermined reward values is associated with a corresponding sample pairing from among the historical listing of pairings; and generate a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

The executable code may further cause the processor to generate a plurality of sample pairings between each group and each category, wherein the generating of the plurality of sample pairings includes pairing each group with each category at least once over the plurality of sample pairings.

Each respective predetermined reward value relates to at least one from among an increased profit, an increased production, and an increased performance.

The executable code may further cause the processor to: determine which corresponding generated sample pairing of the plurality of sample pairings has a highest respective predetermined reward value from the plurality of predetermined reward values, wherein the probability is inversely proportional to a reward gap that is based on a predetermined preferred pairing reward value of an initial preferred pairing and the highest respective predetermined reward value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for recommending optimal pairings between agents and candidates by incentivizing exploration in matching markets, according to an embodiment.

FIG. 2 illustrates a diagram of a network environment for recommending optimal pairings between agents and candidates by incentivizing exploration in matching markets, according to an embodiment.

FIG. 3 illustrates a system diagram of a system for recommending optimal pairings between agents and candidates by incentivizing exploration in matching markets, according to an embodiment.

FIG. 4 illustrates a process diagram of a process for recommending optimal pairings between agents and candidates by incentivizing exploration in matching markets, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein incentivizes exploration in a centralized matching market via a platform that provides recommendations for the job applicants and the employees to explore alternative options. Particularly, the system accesses information about a plurality of agents (e.g., a potential employer, a potential financial advisor, and/or a potential computer-based architectural workflow) that includes categorical information that relates to each respective agent. The system also accesses information about a plurality of candidates (e.g., a potential candidate employee, a potential client, and/or a potential AI agent) that includes grouping information that relates to each respective candidate. The system then generates or retrieves historical pairing data that includes a plurality of different pairings between agents from each category and candidates from each group. Next, the system retrieves a reward value for each historical pairing. Then, the system uses the reward values from the historical pairing to determine which potential pairings would have a highest estimated reward and makes recommendations using a probability based on this value, such that exploration between different categories of agents and groups of candidates are encouraged.

By incentivizing exploration in a centralized matching market based on historical reward values, the system provides better recommendations for both agents and candidates than what would occur naturally. Particularly, the system utilizes a learning algorithm that finds the optimal matching in two-sided markets. Additionally, the system considers the incentive-aware exploration problem in an online matching market from the perspectives of both agents and candidates, such that both parties are incentivized. Moreover, the system may utilize a recommendation policy that is based on the inverse-gap weighting technique in order to accelerate exploration with near-optimal regret guarantees. Furthermore, the system reduces or eliminates biases in matching by encouraging exploration and providing recommendations beyond the typical exploitation in one-to-one matching. Additionally, the system may provide a technical improvement by determining the optimal allocation of system resources, such that particular AI agents may be used or paired with a particular computer-based architectural workflow for solving a technical problem. Additionally, the system may be used to determine optimal pairings in social and healthcare applications.

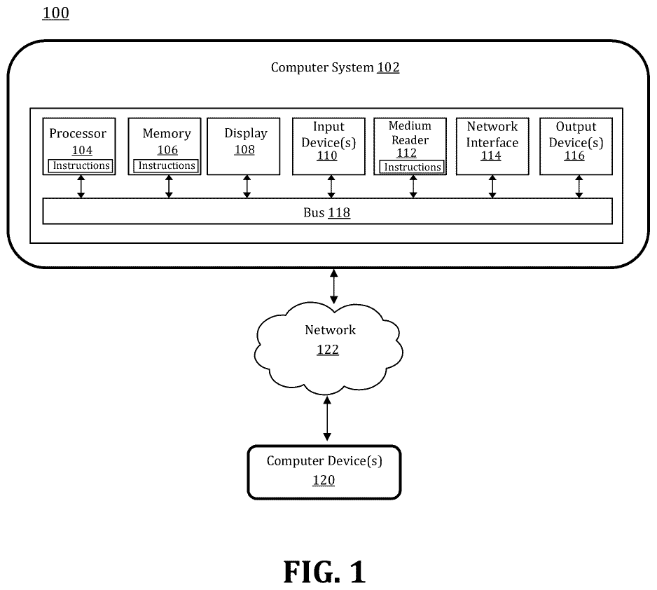

FIG. 1 is a system 100 for recommending optimal pairings between agents and candidates by incentivizing exploration in matching markets, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the two-sided matching module implemented by the system 100 may allow for recommending optimal pairings between agents and candidates by incentivizing exploration in matching markets. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

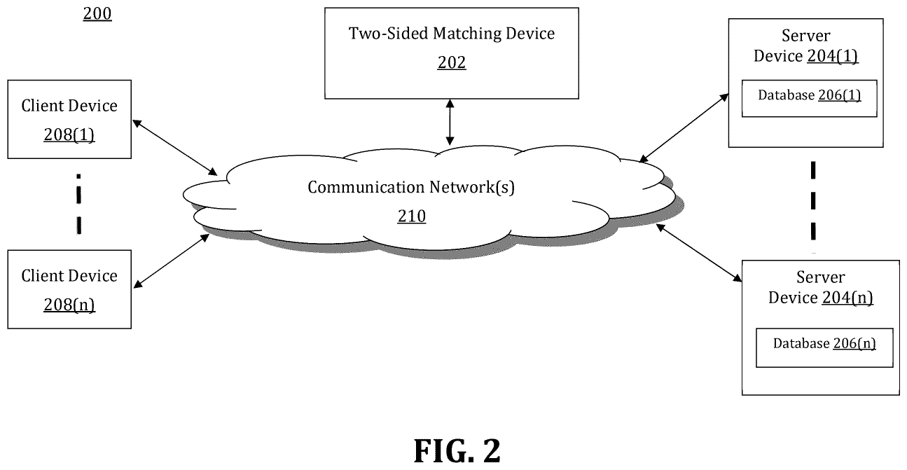

Referring to FIG. 2, a schematic of a network environment 200 for recommending optimal pairings between agents and candidates by incentivizing exploration in matching markets is illustrated.

In some embodiments, the above-described problems associated with conventional tools may be overcome by implementing a two-sided matching device 202 as illustrated in FIG. 2 that may be configured for recommending optimal pairings between agents and candidates by incentivizing exploration in matching markets, but the disclosure is not limited thereto.

The two-sided matching device 202 may include one or more computer systems 102, as described with respect to FIG. 1, which in aggregate provide the necessary functions.

The two-sided matching device 202 may store one or more applications that can include executable instructions that, when executed by the two-sided matching device 202, cause the two-sided matching device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the two-sided matching device 202 itself, may be located in virtual server(s) running in a cloud-based computing environment rather than being tied to one or more specific physical network computing devices. Also, the application(s) may be running in one or more virtual machines (VMs) executing on the two-sided matching device 202. Additionally, in one or more embodiments of this technology, virtual machine(s) running on the two-sided matching device 202 may be managed or supervised by a hypervisor.

In the network environment 200 of FIG. 2, the two-sided matching device 202 may be coupled to a plurality of server devices 204(1)-204(n) that hosts a plurality of databases 206(1)-206(n), and also to a plurality of client devices 208(1)-208(n) via communication network(s) 210. A communication interface of the two-sided matching device 202, such as the network interface 114 of the computer system 102 of FIG. 1, operatively couples and communicates between the two-sided matching device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the two-sided matching device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The two-sided matching device 202 may be a standalone device or integrated with one or more other devices or apparatuses, such as one or more of the server devices 204(1)-204(n), for example. In one example, the two-sided matching device 202 may be hosted by one of the server devices 204(1)-204(n), and other arrangements are also possible. Moreover, one or more of the devices of the two-sided matching device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the two-sided matching device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the two-sided matching device 202 that may recommend optimal pairings between agents and candidates by incentivizing exploration in matching markets, but the disclosure is not limited thereto.

The client devices 208(1)-208(n) may run interface applications, such as standard web browsers or standalone client applications, which may provide an interface to communicate with the two-sided matching device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the two-sided matching device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the two-sided matching device 202, the server devices 204(1)-204(n), or the client devices 208(1)-208(n), for example, may be configured to operate as virtual instances on the same physical machine. For example, one or more of the two-sided matching devices 202, the server devices 204(1)-204(n), or the client devices 208(1)-208(n) may operate on the same physical device rather than as separate devices communicating through communication network(s) 210. Additionally, there may be more or fewer two-sided matching devices 202, server devices 204(1)-204(n), or client devices 208(1)-208(n) than illustrated in FIG. 2. In some embodiments, the two-sided matching device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

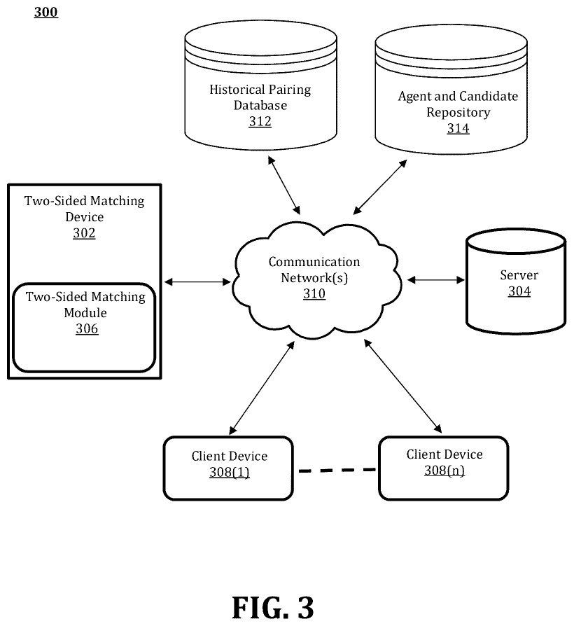

FIG. 3 illustrates a system diagram for recommending optimal pairings between agents and candidates by incentivizing exploration in matching markets, in accordance with an embodiment.

As illustrated in FIG. 3, the system 300 may include a two-sided matching device 302 within which a two-sided matching module 306 is embedded, a server 304, a historical pairing database 312, an agent and candidate repository 314, a plurality of client devices 308(1) . . . 308(n), and a communication network 310.

In some embodiments, the two-sided matching device 302 including the two-sided matching module 306 may be connected to the server 304 the historical pairing database 312 and the agent and candidate repository 314 via the communication network 310. The two-sided matching device 302 may also be connected to the plurality of client devices 308(1) . . . 308(n) via the communication network 310, but the disclosure is not limited thereto. The historical pairing database 312 and the agent and candidate repository 314 may include one or more repositories or databases.

In an embodiment, the two-sided matching device 302 is described and shown in FIG. 3 as including the two-sided matching module 306, although it may include other rules, policies, modules, databases, or applications, for example. In some embodiments, the historical pairing database 312 and the agent and candidate repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the historical pairing database 312 and the agent and candidate repository 314 may be a mainframe database, a log database that may produce programming for searching, monitoring, and analyzing machine-generated data via a web interface, but the disclosure is not limited thereto. In addition, the historical pairing database 312 and the agent and candidate repository 314 may store a plurality of data sets and predictive models for recommending optimal pairings.

In some embodiments, the two-sided matching module 306 may be configured to receive a real-time feed of data from the plurality of client devices 308(1) . . . 308(n) and secondary sources via the communication network 310.

The two-sided matching module 306 may be configured to: access information that relates to a plurality of agents, wherein each respective agent of the plurality of agents is associated with a respective category from among a plurality of categories, and wherein each respective category of the plurality of categories is associated with a respective predetermined feature from a set of features; access information that relates to a plurality of candidates, wherein each respective candidate of the plurality of candidates is associated with one respective group from among a plurality of groups, and wherein each respective group of the plurality of groups is associated with a respective predetermined characteristic from a set of characteristics; retrieve a historical listing of pairings between each respective group and each respective category; retrieve a plurality of predetermined reward values, wherein each respective predetermined reward value from among the plurality of predetermined reward values is associated with a corresponding sample pairing from among the historical listing of pairings; and generate a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

The plurality of client devices 308(1) . . . 308(n) are illustrated as being in communication with the two-sided matching device 302. In this regard, the plurality of client devices 308(1) . . . 308(n) may be “clients” (e.g., customers) of the two-sided matching device 302 and are described herein as such. Nevertheless, it is to be known and understood that the plurality of client devices 308(1) . . . 308(n) need not necessarily be “clients” of the two-sided matching device 302, or any entity described in association therewith herein. Any additional or alternative relationship may exist between either or both plurality of client devices 308(1) . . . 308(n) and the two-sided matching device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the two-sided matching device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The two-sided matching device 302 may be the same or similar to the two-sided matching device 202 as described with respect to FIG. 2, including any features or combination of features described with respect thereto.

Upon being started, the two-sided matching device 302 executes a process for recommending optimal pairings between agents and candidates by incentivizing exploration in matching markets.

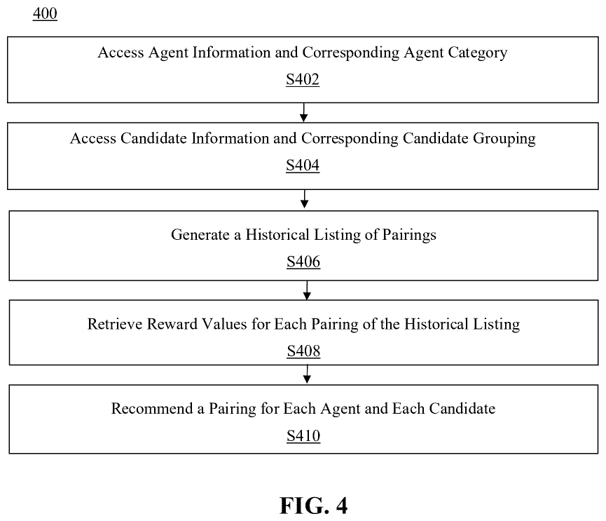

FIG. 4 illustrates a process 400 for recommending optimal pairings between agents and candidates by incentivizing exploration in matching markets, according to an embodiment.

In process 400 of FIG. 4, at step S402, the two-sided matching device 302 may access information that relates to a plurality of agents. The information may be accessed via a database or repository of agents and agent information (e.g., website, application, portal, and/or agent and candidate repository 314). In an embodiment, an agent may include a person, entity, module, or component that is requesting or requires a pairing or matching with another person, entity, module, or component (i.e., candidate) to perform a service, task, job, or opportunity. For example, the agent may include a potential employer, a potential financial advisor, or a potential computer-based architectural workflow. The information may include the features, qualities, and/or attributes of the agent which may be associated with a corresponding category for which the agent belongs. For example, in an embodiment, the information may include the work experience of a financial advisor, such that the financial advisor is categorized as a senior financial advisor. In some embodiments, the information may include the number of employees employed by an employer, such that the employer is described as large employer.

At step S404, the two-sided matching device 302 may access information that relates to a plurality of candidates. The information may be accessed via a database or repository of candidates and candidate information (e.g., agent and candidate repository 314). In an embodiment, a candidate may include a person, entity, module, or component that is requesting to be paired or matched with an agent to perform a service, task, job, or opportunity requested by the agent. For example, the candidate may include a potential candidate employee, a potential client, or a potential AI agent. The information may include the features, qualities, and/or attributes of the candidate which may be associated with a corresponding group for which the candidate belongs. For example, in an embodiment, the information may include that the client is a business with a large portfolio, such that the client is categorized as a big business. In some embodiments, the information may include the work experience of the candidate employee, such that the employee is described as a preferred candidate.

At step S406, the two-sided matching device 302 may generate a historical listing of prior pairings. In an embodiment, the two-sided matching device 302 may generate the historical listing of prior pairings by generating a plurality of sample pairings between each group and each category. For example, in an embodiment, the sample agents in the sample pairings may include two different categories of agents, x₁ agents and x₂ agents. The sample candidates in the sample pairings may include two different groups of candidates, a₁ candidates and a₂ candidates. The sample pairings may include respective pairings where each respective category of agents is paired with a respective group of candidates. For example, the sample pairings may include a pairing of an x₁ agent with an a₁ candidate, a pairing of an x₁ agent with an a₂ candidate, a pairing of an x₂ agent with an a₁ candidate, and a pairing of an x₂ agent with an a₂ candidate.

At step S408, the two-sided matching device 302 may retrieve respective predetermined reward values for each corresponding sample pairing. The predetermined reward values may be retrieved from a database or repository of historical pairing data (e.g., the historical pairing database). The predetermined reward values may be the actual realized rewards that were received in the historical pairings. In an embodiment, the reward value may include what the agent and/or candidate may receive as a benefit from the pairing. For example, the reward value may include an amount of profit, production, and/or increased performance. In an embodiment, each respective reward value may be estimated based on an inverse proportionality of a difference between a first advantage value of an initial preferred pairing and a second advantage value of the corresponding generated sample pairing. The first advantage value may relate to the realized reward value for the initial preferred pairing. The second advantage value may relate to the realized reward value for the corresponding sample pairing. In an embodiment, the initial preferred pairing may refer to a match or pairing that both the agent and the candidates would prefer or select on their own. For example, x₁ agents may prefer to match with a₁ candidates, and a₁ candidates may prefer to match with x₁ agents. In an embodiment, the two-sided matching device 302 may determine which corresponding generated sample pairing of the plurality of sample pairings has a highest estimated respective reward. The highest estimated respective reward may be based on which sample pairing has the highest inverse proportionality.

At step S410, the two-sided matching device 302 may recommend a pairing for each agent and each candidate. In an embodiment, a probability that a particular recommendation is made may be based on the historical listing and the plurality of reward values. In some embodiments, the probability may be inversely proportional to a reward gap that is based on a predetermined preferred pairing reward of the preferred pairing and the highest estimated respective reward. For example, when x₁ agents prefer to match with a₁ candidates and a₁ candidates prefer to match with x₁ agents, and this pairing has the highest predetermined advantage value, this pairing would have the highest inverse proportionality, and thus would have the highest probability and would be recommended more often than other potential pairings. In an embodiment, the probability may be greater than or equal to zero.

In some embodiments, an agent may be a potential computer-based architectural workflow, and a candidate may be an AI agent. The two-sided matching device 302 may recommend or choose the appropriate pairing or match between the workflow and the AI agent that is optimal based on reward value that is related to an optimization of system resources. For example, the two-sided matching device 302 may provide recommendations for a select group of AI agent to perform a particular category of computer-based architectural workflow that lowers the required operational resources for the plurality of AI agents as well has the operational system in which the workflow is based.

In an embodiment, the two-sided matching device 302 may utilize an end-to-end Bayesian Incentive-Compatible (BIC) algorithm with two components: ‘warm-start’ and accelerated exploration. Particularly, the two-sided matching device 302 may generate a novel recommendation policy based on the inverse-gap weighting technique to accelerate exploration with near-optimal regret guarantees. The end-to-end algorithm may be both 1) incentive-compatible and 2) efficient in terms of regret minimization.

In some embodiments, the algorithm may be based on [K]={1, 2, . . . , K} for K∈N⁺. Subscripts i, j may denote different agents or candidates, and superscript t∈[T] may denote different time-steps. The two-sided matching device 302 may be used in an online two-sided matching market with time horizon T. At time-step t∈[T], a fresh batch of N agents and N candidates may arrive and form N one-to-one matches. If they successfully match with some candidates, the agents (and candidates) report their shared utility to the platform and leave.

In some embodiments, the two-sided matching device 302 may formulate rewards and functions under the assumption that the reward of each successful match is a bilinear function of the agent and the candidates' profiles. Concretely, at time-step t, each agent of type i has their user profile x^{(t)}∈R^{d}. Similarly, each candidate of type j has profile vector

$${a}_{j}^{( t )} ∈ {R}^{d} .$$

Let Σ∈R^{d×d} be a latent matrix with rank r<d. Then, the realized reward of a match (type i agent, type j candidate) is:

$${r}_{i , j}^{( t )} = {r}^{( t )} ( {x}_{i}^{( t )} , {a}_{j}^{( t )} ) := {( {x}_{i}^{( t )} )}^{⊤} Σ {a}_{j}^{( t )} + {η}_{i , j}^{( t )} \qquad ( 1 )$$

where

$${η}_{i , j}^{( t )} \sim subG ( σ ) .$$

In an embodiment,

$${μ}_{i , j} = {x}_{i}^{⊤} Σ {a}_{j}$$

may denote the expected reward of a match between agents of type i and candidates of type j, and

$${μ}_{i , j}^{( 0 )}$$

may denote the prior-mean reward. Without loss of generality (Wlog), it is assumed that ∀i,j: μ_{i,j}∈[0, 1]. Henceforth, xᵢ and aⱼ refer to agents of type i and candidates of type j.

In an embodiment, a stylized setting with two types of agents and candidates, may be the focus. i, j∈[2] may denote the type of agents and candidates, respectively. There may be two sets of preferences: agent-to-candidate and candidate-to-agent. For example, job applicants may want to be matched with compatible employers and employers prefer to be matched with applicants who can perform well. Wlog, it is assumed that the initial preference ordering is

$${μ}_{1.1}^{( 0 )} \geq {μ}_{1.2}^{( 0 )} \geq {μ}_{2.2}^{( 0 )} and {μ}_{1.1}^{( 0 )} \geq {μ}_{2.1}^{( 0 )} \geq {μ}_{2.2}^{( 0 )} .$$

That is, all agents prefer type 1 candidates to type 2 candidates, and all candidates prefer type 1 agents to type 2 agents.

Absent incentives and coordination from the two-sided matching device 302, the agents and candidates match each other using their initial preferences. However, the two-sided matching device 302 wants to incentivize both the agents and the candidates to explore different options to find the optimal matching and maximize the cumulative reward. In particular, at each time step t, the two-sided matching device 302 may broadcast a signal s (1) as a recommendation to all agents and candidates. This signal may be equivalent to directly telling the agents which candidate to match with, and vice versa.

In some embodiments, the two-sided matching device 302 may utilize a two-sided BIC Condition. ∀t∈[T], the recommendation of the two-sided matching device 302 may be ϵ-two-sided Bayesian Incentive-Compatible (ϵ-BIC) for some ϵ>0 if it satisfies:

$$𝔼 [ {r}_{i , j}^{( t )} \vert rec = ( {x}_{i}^{( t )} , {a}_{j}^{( t )} ) ] - {sup}_{ℓ ∈ [ 𝒩 ]} 𝔼 [ {r}_{i , j}^{( t )} \vert rec = ( {x}_{i}^{( t )} , {a}_{j}^{( t )} ) ] \geq ϵ \qquad ( 2 )$$

$$𝔼 [ {r}_{i , j}^{( t )} \vert rec = ( {x}_{i}^{( t )} ; {a}_{j}^{( t )} ) ] - {sup}_{ℓ ∈ [ 𝒩 ]} 𝔼 [ {r}_{i , j}^{( t )} \vert rec = ( {x}_{i}^{( t )} , {a}_{j}^{( t )} ) ] \geq ϵ \qquad ( 3 )$$

In an embodiment, the two-sided matching device 302 may make a behavioral assumption, such that agents and candidates follow recommendations for any ϵ₀-BIC policy, for some fixed ϵ₀>0. If one side rejects the recommendation, then both sides of the recommended (agent, candidate) pair do have a match for that time-step and the platform receives a reward of 0 for that recommended pair. Both the agents and the candidates are assumed to be myopic, i.e., they will choose the posterior best candidates (agents) at the current time-step to match with.

In some embodiments, the two-sided matching device 302 may include a platform to reduce the two-sided matching problem to a combinatorial semi-bandits problem, in which, at each time-step, the set of all feasible matches between agents and candidates constitutes the action space A⊂R^{N×N}. An atom

$$( {x}_{i}^{( t )} , {a}_{j}^{( t )} )$$

is a match between

$${x}_{i}^{( t )} and {a}_{j}^{( t )} ,$$

and there are N² total atoms. An action A^{(t)}∈ [symbol] at time-step t is the combination of matches at that round, where ∥A^{(t)}∥ [symbol] ≤N. At each time-step t, a learner arrives at the platform, receives a recommendation for an action A∈, [symbol] and chooses an action A(t)− [symbol] . The platform and the learner both observe the reward of each atom in this candidate (and nothing else). The algorithm's reward in this time-step is the total reward of these atoms.

In an embodiment, incentivized exploration may be utilized with two types of agents and candidates. In essence, the two-sided matching device 302 first incentivizes all agents and candidates to match each other and collect samples from these matches. Then, the two-sided matching device 302 may use these ‘warm-start’ samples to accelerate exploration and quickly converge to the optimal matching.

In some embodiments, the two-sided matching device 302 may utilize a BIC algorithm to collect the ‘warm-start’ samples, where the objective is to sample each atom, i.e., match between an agent and a candidate, at least once and complete in T₀ time-steps for some T₀ determined by the prior time-step. Based on the following algorithm, in the ‘worst case’ with one ‘explorable’ atom initially, both the agents and the candidates may be incentivized to explore different matches. Intuitively, given enough samples of the ‘explorable’ atom, the two-sided matching device 302 may split the remaining time-steps into phases such that in each phase, a new atom, i.e., a match between an agent and a candidate that was previously not explorable, can be chosen by the learner upon receiving the principal's recommendation. The two-sided matching device 302 may provide a sequence of actions and prove that it is possible to incentivize both the agents and the candidates to explore given some mild conditions on the posterior distribution of the reward for each atom.

In an embodiment, the two-sided matching device 302 may make the following non-degeneracy assumption: any action A_{cand} can be the posterior best action with a margin τ_{P} and probability at least ρ_{P} after seeing at least n_{P} samples of the previous actions. Thus, the two-sided matching device 302 may make a fighting chance assumption, such that there exists number n_{P}∈N and τ_{P}, ρ_{P}∈(0, 1) determined by the prior P such that: for a sequence of actions

$${A}_{cand}^{1} , … , {A}_{cand}^{{N}^{2}}$$

defined by NextCandidate ( [symbol] , S, P). Let S be the dataset containing exactly k∈N samples of each candidate, then,

$$\begin{matrix}Pr [ {X}_{i}^{k} \geq {τ}_{p} ] \geq ρ p & ∀ i ∈ 𝒜 and k \geq {n}_{p} ,\end{matrix} \qquad ( 4 )$$

$$where {X}_{i}^{k} = {min}_{\text{?} A \neq {A}_{cand}} 𝔼 [ {μ}_{{A}_{cand}} - {μ}_{A} [ 𝒮 ]$$

$$\text{?} \text{indicates text missing or illegible when filed}$$

In an embodiment, the initial sampling algorithm may be illustrated by Algorithm 1 and its theoretical guarantees in Theorem 2.

Algorithm 1: Initial sampling: Hidden Exploration

```
Input: Batch size L ∈ [symbol] , target number of samples k ∈ [symbol] . gap C ∈ (0, 1).
  1: Initialize dataset S = Ø;
  $2 : The first k learners choose A = \{ ( {x}_{1} , {a}_{1} ) \} without recommendations . Let \text{?} be the smape$
average of these rewards. Add these k samples to S;
  3: for each phase ψ = 1 to N² do
  $4 : A \text{?} = NextCandidate ( 𝒜 , 𝒮 , 𝒫 ) ;$
  $5 : if \text{?} \leq {μ}_{{A}_{cand}^{ψ}}^{( 0 )} - C then$
  $6 : ‘ Exploit ’ action {A}^{*} = {A}_{cand}^{ψ} \text{?}$
  7: else
  8: ‘Exploit’ action A* = {(x₁, a₁)}.
  9: From the set P of the next L · k learners, pick a set Q of k learners uniformly at random;
10: Every learner p ∈ P − Q is recommended the ‘exploit’ action A*;
11: Every learner p ∈ Q is recommended action A_{cand}. Add the reward from all p ∈ Q to S.
$\text{?} \text{indicates text missing or illegible when filed}$
```

Theorem 2. Assuming the fighting chance assumption holds with constants n_{P}, τ_{P}, ρ_{P}. Then, Algorithm 1 is two-sided ϵ-BIC as long as the batch size L is at least

$$L \geq 1 + max \{ \frac{2 + 2 ϵ}{τ p \cdot ρ p - 2 ϵ} , \frac{2 ϵ}{{μ}_{1 , 2}^{( 0 )} + {μ}_{2 , 1}^{( 0 )} - {μ}_{2 , 2}^{( 0 )} + 𝔼 [ {Δ}_{{A}^{\text{?}} , {A}_{2.2}}^{k} [ {ξ}_{3} ] Pr [ {ξ}_{\text{?}} ] - 2 ϵ} \} \qquad ( 5 )$$

$$\text{?} \text{indicates text missing or illegible when filed}$$

and completes in

$${T}_{0} = {N}^{2} \cdot {n}_{p} \cdot \frac{1 + {N}^{2}}{τ p \cdot ρ p}$$

time-steps. All actions are sampled at least nₚ times.

Given the data collected by Algorithm 1, the two-sided matching device 302 may want to accelerate exploration and converge to the optimal matching. The two-sided matching device 302 has to balance exploitation, i.e., recommending the empirical best match to minimize regret, and exploration, i.e., ensuring that the two-sided BIC condition holds. The theoretical underpinning of the recommendation policy at this stage is inverse gap weighting, i.e., recommending a match with probability inversely proportional to the reward gap between that match and the empirical best match. Formally, we let

$${b}^{( ℓ )} = arg {max}_{A ∈ {A}_{A}^{{\hat{p}}^{( t )}}}$$

denote the empirical best action at time-step t. Then, the probability of an action A being recommended at time-step t is:

$${p}_{A}^{( t )} = \{ \begin{matrix}\frac{1}{{N}^{2} + γ ( {\hat{r}}_{{b}^{( t )}}^{( t )} - {{r}^{\hat{}}}_{A}^{( t )} )} & if A \neq {b}^{( t )} \\ 1 - {\sum }_{A \neq {b}^{( t )}} {p}_{A}^{( t )} & otherwise\end{matrix}$$

where the hyperparameter γ>0 shows the tradeoff between exploration and exploitation. A smaller γ leads to more exploration, while a larger γ induces more exploitation. To ensure that γ is adaptive to the samples collected, the two-sided matching device 302 may be configured to set γ=C₀·N\sqrt{1/φ^{(t)}}, where φ^{(t)} is the mean squared error of the prediction at time-step t. It is assumed that there exists an efficient regression-oracle that accurately computes φ^{(t)} at time-step t. With this recommendation policy, we state the theoretical guarantee for accelerated exploration by an informal theorem, in which, given sufficiently many ‘warm-start’ samples of all atoms, the inverse gap weighting recommendation policy is two-sided ϵ-BIC. The total regret during this stage is O( [symbol] \sqrt{dT log(T)}), which asymptotically matches the optimal regret of combinatorial semi-bandits.

For example, in accordance with an embodiment, consider a stylized setting with two types of agents and candidates and a time horizon of T. In the first T₀ time-steps, the two-sided matching device 302 may run a black-box recommendation algorithm such that, at the end of T₀ time-steps, the agents always follow the recommendation of the two-sided matching device 302 and take the recommended candidate. We show that there exists a problem instance where in the remaining T−T₀ time-steps, the algorithm incurs regret Ω(T−T₀).

The two-sided matching device 302 may examine when a stable matching can happen without external incentives. The number of possible matchings between two agents and two candidates is 2⁴=16 (each agent has two choices for which candidate they prefer, and vice versa). Due to symmetry among the agents and the candidates (e.g., a matching {(x₁, a₁), (x₂, a₂)} is equivalent to the matching {(x₁, a₂), (x₂, a₂)} by renaming the variables a₁ to a₂), there are five possible unique matchings between agents x₁, x₂ to candidates a₁, a₂.

Among these unique matchings, only one is stable according to the initial preferences: x₁ with a₁, and x₂ with a₂. If the optimal solution falls into this case (or its isomorphic forms), then the two-sided matching device 302 does not need to run an incentivized exploration algorithm to achieve optimal matching. However, for the remaining four possibilities, there always exists a possible realization of the rewards such that the initial preferences of either the agents or the candidates will block an optimal matching (due to incompatible preference from either side) and any non-incentive-aware learning algorithm would incur linear regret.

Accordingly, with this technology, an optimized process for recommending optimal pairings between agents and candidates by incentivizing exploration in matching markets is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for matching agents with candidates, the method being implemented by at least one processor, the method comprising:
accessing, by the at least one processor, information that relates to a plurality of agents, wherein each respective agent of the plurality of agents is associated with a respective category from among a plurality of categories, and wherein each respective category of the plurality of categories is associated with a respective predetermined feature from a set of features;
accessing, by the at least one processor, information that relates to a plurality of candidates, wherein each respective candidate of the plurality of candidates is associated with one respective group from among a plurality of groups, and wherein each respective group of the plurality of groups is associated with a respective predetermined characteristic from a set of characteristics;
retrieving, by the at least one processor, a historical listing of pairings between each respective group and each respective category;
retrieving, by the at least one processor, a plurality of predetermined reward values, wherein each respective predetermined reward value from among the plurality of predetermined reward values is associated with a corresponding sample pairing from among the historical listing of pairings; and
generating, by the at least one processor, a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

2. The method of claim 1, further comprising:
generating the historical listing of pairings by generating, by the at least one processor, a plurality of sample pairings between each group and each category, wherein the generating of the plurality of sample pairings includes pairing each group with each category at least once over the plurality of sample pairings.

3. The method of claim 2, wherein each respective predetermined reward value relates to at least one from among an increased profit, an increased production, and an increased performance.

4. The method of claim 2, further comprising:
determining, by the at least one processor, which corresponding generated sample pairing of the plurality of sample pairings has a highest respective predetermined reward value from the plurality of predetermined reward values,
wherein the probability is inversely proportional to a reward gap that is based on a predetermined preferred pairing reward value of an initial preferred pairing and the highest respective predetermined reward value.

5. The method of claim 4, wherein the probability is greater than or equal to zero.

6. The method of claim 1, wherein each of the plurality of agents is a potential employer and each of the plurality of candidates is a potential candidate employee.

7. The method of claim 1, wherein each of the plurality of agents is a potential financial advisor and each of the plurality of candidates is a potential client.

8. The method of claim 1, wherein each of the plurality of agents is a potential computer-based architectural workflow and each of the plurality of candidates is a potential artificial intelligence (AI) agent.

9. A computing apparatus for matching agents with candidates, the computing apparatus comprising:
a processor;
a memory; and
a communication interface coupled to each of the processor and the memory,
wherein the processor is configured to:
access information that relates to a plurality of agents, wherein each respective agent of the plurality of agents is associated with a respective category from among a plurality of categories, and wherein each respective category of the plurality of categories is associated with a respective predetermined feature from a set of features;
access information that relates to a plurality of candidates, wherein each respective candidate of the plurality of candidates is associated with one respective group from among a plurality of groups, and wherein each respective group of the plurality of groups is associated with a respective predetermined characteristic from a set of characteristics;
retrieve a historical listing of pairings between each respective group and each respective category;
retrieve a plurality of predetermined reward values, wherein each respective predetermined reward value from among the plurality of predetermined reward values is associated with a corresponding sample pairing from among the historical listing of pairings; and
generate a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

10. The computing apparatus of claim 9, wherein the processor is further configured to generate a plurality of sample pairings between each group and each category, wherein the generating of the plurality of sample pairings includes pairing each group with each category at least once over the plurality of sample pairings.

11. The computing apparatus of claim 10, wherein each respective predetermined reward value relates to at least one from among an increased profit, an increased production, and an increased performance.

12. The computing apparatus of claim 10, wherein the processor is further configured to:
determine which corresponding generated sample pairing of the plurality of sample pairings has a highest respective predetermined reward value from the plurality of predetermined reward values,
wherein the probability is inversely proportional to a reward gap that is based on a predetermined preferred pairing reward value of an initial preferred pairing and the highest respective predetermined reward value.

13. The computing apparatus of claim 12, wherein the probability is greater than or equal to zero.

14. The computing apparatus of claim 9, wherein each of the plurality of agents is a potential employer and each of the plurality of candidates is a potential candidate employee.

15. The computing apparatus of claim 9, wherein each of the plurality of agents is a potential financial advisor and each of the plurality of candidates is a potential client.

16. The computing apparatus of claim 9, wherein each of the plurality of agents is a potential computer-based architectural workflow and each of the plurality of candidates is a potential artificial intelligence (AI) agent.

17. A non-transitory computer readable storage medium storing instructions for matching agents with candidates, the storage medium comprising executable code which, when executed by a processor, causes the processor to:
access information that relates to a plurality of agents, wherein each respective agent of the plurality of agents is associated with a respective category from among a plurality of categories, and wherein each respective category of the plurality of categories is associated with a respective predetermined feature from a set of features;
access information that relates to a plurality of candidates, wherein each respective candidate of the plurality of candidates is associated with one respective group from among a plurality of groups, and wherein each respective group of the plurality of groups is associated with a respective predetermined characteristic from a set of characteristics;
retrieve a historical listing of pairings between each respective group and each respective category;
retrieve a plurality of predetermined reward values, wherein each respective predetermined reward value from among the plurality of predetermined reward values is associated with a corresponding sample pairing from among the historical listing of pairings; and
generate a recommended corresponding pairing for each respective agent and each respective candidate, wherein a probability that the recommended corresponding pairing is generated is based on the historical listing and the plurality of predetermined reward values, and wherein each corresponding pairing includes one agent from among the plurality of agents and one candidate from among the plurality of candidates.

18. The storage medium of claim 17, wherein the executable code further causes the processor to generate a plurality of sample pairings between each group and each category, wherein the generating of the plurality of sample pairings includes pairing each group with each category at least once over the plurality of sample pairings.

19. The storage medium of claim 18, wherein each respective predetermined reward value relates to at least one from among an increased profit, an increased production, and an increased performance.

20. The storage medium of claim 18, wherein the executable code further causes the processor to:
determine which corresponding generated sample pairing of the plurality of sample pairings has a highest respective predetermined reward value from the plurality of predetermined reward values,
wherein the probability is inversely proportional to a reward gap that is based on a predetermined preferred pairing reward value of an initial preferred pairing and the highest respective predetermined reward value.
